(19) United States
(12) Patent Application Publication
(10) Pub. No.: US 2017/0285585 A1
(43) Pub. Date: Oct. 5, 2017

(54) TECHNOLOGIES FOR RESOLVING MORAL CONFLICTS DURING AUTONOMOUS OPERATION OF A MACHINE

(71) Applicants: John C. Weast, Portland, OR (US); Tobias M. Kohlenberg, Portland, OR (US); Brian D. Johnson, Portland, OR (US)

(72) Inventors: John C. Weast, Portland, OR (US); Tobias M. Kohlenberg, Portland, OR (US); Brian D. Johnson, Portland, OR (US)

(21) Appl. No.: 15/089,541

(22) Filed: Apr. 2, 2016

(51) Int. Cl. G05B 13/02; G06N 99/00; G05D 1/00; G06N 5/04

(52) U.S. Cl. CPC G05B 13/028; G06N 5/045; G06N 5/046; G06N 99/005; G05D 1/0088

(57) ABSTRACT

Technologies for controlling a machine include a compute system configured to control operation of the machine. The compute system is configured to detect a moral conflict related to the operation of the machine and determine operational choices for operation of the machine to resolve the moral conflict. The compute system also determines a moral agent likely to be affected by each operational choice and one or more moral rules applicable to the moral conflict. The moral agents may be weighted based on a set of weighting rules, which may vary based on geographical location and/or other criteria. Each moral rule defines a goal to be achieved by the operation of the machine. The compute system is further configured to select one of the operational choices to resolve the conflict based on the determined moral agents and the moral rules and control the machine to perform the selected operational choice.

### BACKGROUND

Autonomous control is an increasingly applied technology to control the operation of machines with little or no human interaction or direction. Autonomous machines, such as autonomous vehicles, are controlled by a compute system associated with the machine itself. Such compute systems typically control the operation of the machine based on, at least in part, hard-coded rules to ensure safe and efficient operation of the controlled machine.

Although the hard-coded rules provide a well-structured framework from which to operate the controlled machine under most circumstance, the hard-coded rules typically provide poor resolution to moral conflicts (e.g., choosing the best of two poor choices). Should the compute system experience such a moral conflict for which the hard-coded rules do not define or provide a clear action to be taken, a typical compute system of a controlled machine will shut down or return control to a human user. For example, in a situation in which an autonomous vehicle is faced with the two decisions to either impact a jaywalking person who has jumped into the roadway or swerve onto a nearby sidewalk to miss the jaywalking person while striking a bystander, the autonomous vehicle may be unable to make such a decision based on the standard operation rules. As a result, the autonomous vehicle may simply return control to the driver to deal with the complicated moral decision of choosing which person to possibly injury.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for a controlled machine including a compute system configured to control operation of the controlled machine;

FIG. 2 is a simplified illustration of another embodiment of the system of FIG. 1;

FIG. 2 is a simplified block diagram of at least one embodiment of the compute system of the controlled machines of FIGS. 1 and 2;

FIG. 3 is a simplified block diagram of at least one embodiment of an environment that may be established by the compute system of FIG. 2;

FIG. 4 is a simplified block diagram of at least one embodiment of a moral agent database that may be managed by the compute system of FIG. 2;

FIG. 5 is a simplified block diagram of at least one embodiment of a weighting rule database that may be managed by the compute system of FIG. 2;

FIG. 6 is a simplified block diagram of at least one embodiment of a moral rule database that may be managed by the compute system of FIG. 2;

FIGS. 7 and 8 are a simplified flow diagram of at least one method for controlling a machine that may be executed by the compute system of FIG. 2;

FIG. 9 is a simplified flow diagram of at least one method for updating rule data that may be executed by the compute system of FIG. 2; and

FIG. 10 is a simplified flow diagram of at least one method for sharing rule data that may be executed by the compute system of FIG. 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A or C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

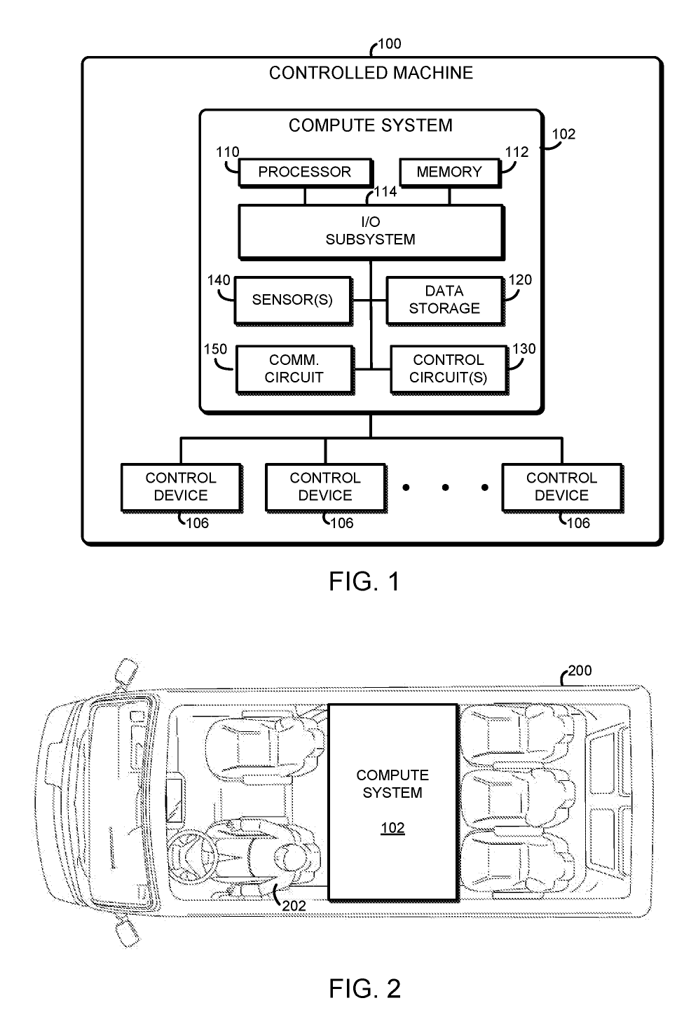

Referring now to FIG. 1, an illustrative controlled machine 100 includes a compute system 102 configured to control the operation of the controlled machine 100. The controlled machine 100 may be embodied as any type of machine capable of being controlled by the compute system 102 including, but not limited to, a highly automated and/or autonomous vehicle, a highly automated and/or autonomous excavator, a highly automated and/or autonomous delivery system, a highly automated and/or autonomous robot, a highly automated and/or autonomous drone, a highly automated and/or autonomous military machine, a highly automated and/or autonomous industrial machine, or any other type of machine having operations capable of being controlled by an associated compute system.

During normal operation, the compute system 102 controls the operation of the controlled machine 100 based on a set of operation rules, which may define standard rules for operating the controlled machine (e.g., do not harm people, obey all roadway laws, etc.). During operation, however, the compute system 102 monitors for a moral conflict related to the operation of the controlled machine 100. The moral conflict may be embodied as any type of conflict or decision that must be made and which is not defined or solvable by the operation rules. For example, the compute system 102 may identify a moral conflict during control of the controlled machine 100 in response to a situation in which operation of the machine violates one or more operational rules (e.g., a person is likely to be injured by the operation).

Once the compute system 102 has identified the moral conflict, the compute system 102 determines which operational choices may be taken to resolve the moral conflict. Of course, in some circumstances, the operational choices define the moral conflict itself. After the operational choices have been determined, the compute system 102 determines which moral agents are likely to be affected by each operational choice. As discussed in more detail below, each moral agent is an abstraction of a real-world entity that is likely to be affected (e.g., damaged, harmed, or injured) by the operational choice. For example, a real-world entity may be embodied as a house in a certain moral conflict situation, and the compute system 102 may determine that the moral agent equivalent for that house is defined as “physical structure,” “building,” and/or “home.”

After the moral agents associated with the operational choices to resolve the moral conflict have been identified, the compute system 102 determines and applies one or more weighting factors to identified moral agents. To do so, the compute system 102 maintains a database of weighting factors applicable to each moral agent. As discussed in more detail below, each weighting factor defines an importance or value of the corresponding moral agent in the present society, time, environment, or according to some other criteria. As such, the weight of moral agents may change across different societies (e.g., some societies may value dogs greater than other societies), across time (e.g., the value of property may decrease or increase over time), and/or across environments (e.g., a fire hydrant may be more valuable in a draught-ridden environment).

The compute system 102 also determines one or more moral rules applicable to the identified moral conflict. That is, the compute system 102 also maintains a database of moral rules that define goals to be achieved by the operation of the controlled machine 100. As discussed below, the moral rules may be defined based on local law, morals, ethics, and/or other criteria. The moral rules are different from the standard operation rules. For example, as goals, some or all of the moral rules applicable to the moral conflict may not be satisfied, or not completely satisfied, by the determined operational choices. As such, the compute system 102 selects the operational choice to be implemented by maximizing the number satisfied applicable moral rules and/or maximizing the satisfaction of the applicable moral rules. For example, a moral rule may dictate to “minimize injury to persons” and “minimize damage to property.” Both moral rules may be not be achievable by any one operational choice in some situations. As such, to select the operational choice to be implemented, the compute system 102 may maximize the satisfaction of one of those moral rules (e.g., selecting the operational choice that “maximizes” the minimization of injury to persons). In doing so, the compute system 102 utilizes the weighting factors applied to each moral agent to determine which operational choice maximizes the satisfaction of the moral rules (e.g., minimizing damage to property based on the weighting factors applied to the different moral agents).

After the compute system 102 has selected the operational choice to be implemented based on the weighted moral agents and the applicable moral rules, the compute system 102 controls the controlled machine 100 to perform the operational choice. As discussed above, the operational choice defines a particular operation of the controlled machine 100, which is performed by the compute system to implement the selected operational choice. In some embodiments, the weighting factors and/or moral rules may be updated based on the result of the selected operational choice (e.g., was the result desirable by a user of the controlled machine). Additionally, in some embodiments, the compute system 102 may share data related to the moral agents, weighting factors, and/or moral rules with other compute systems controlling other machines.

As shown in FIG. 1, the compute system 102 forms a portion of the controlled machine 100 in the illustrative embodiment. However, in other embodiments, the compute system 102 may be remote from, but communicatively coupled to, the controlled machine 100 (e.g., in an autonomous convey belt system). The compute system 102 may be embodied as any type of computer, processing system, or controller capable of controlling the operation of the controlled machine 100. For example, the compute system 102 may be embodied as an in-vehicle compute system, an in-vehicle infotainment system, a server computer, a distributed computing system, a multiprocessor system, a consumer electronic device, a smart appliance, and/or any other compute device capable of controlling the controlled machine 100 and performing the functions described herein. The illustrative compute system 102 includes processor 110, a memory 112, an input/output subsystem 114, a data storage 120, one or more control circuits 130, one or more sensors 140, and a communication circuit 150. Of course, the compute system 102 may include other or additional components, such as those commonly found in computer devices (e.g., various input/output devices, etc.), in other embodiments. Additionally, in some embodiments, one or more of the illustrative components may be incorporated in, or otherwise from a portion of, another component. For example, the memory 112, or portions thereof, may be incorporated in the processor 110 in some embodiments.

The processor 110 may be embodied as any type of processor capable of performing the functions described herein. For example, the processor may be embodied as a single or multi-core processor(s) having one or more processor cores, a digital signal processor, a microcontroller, or other processor or processing/controlling circuit. Similarly, the memory 112 may be embodied as any type of volatile and/or non-volatile memory or data storage capable of performing the functions described herein. In operation, the memory 112 may store various data and software used during operation of the compute system 102 such as operating systems, applications, programs, moral agent data, weighting factor data, moral rules data, libraries, and drivers. The memory 112 is communicatively coupled to the processor 110 via the I/O subsystem 114, but may be directly coupled to the processor 110 in other embodiments (e.g., in those embodiments in which the processor 110 includes an on-board memory controller).

The I/O subsystem 114 may be embodied as circuitry and/or components to facilitate input/output operations with the processor 110, the memory 112, and other components of the compute system 102. For example, the I/O subsystem 114 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 114 may form a portion of a system-on-a-chip (SoC) and be incorporated, along with the processor 110, the memory 112, and other components of the compute system 102, on a single integrated circuit chip.

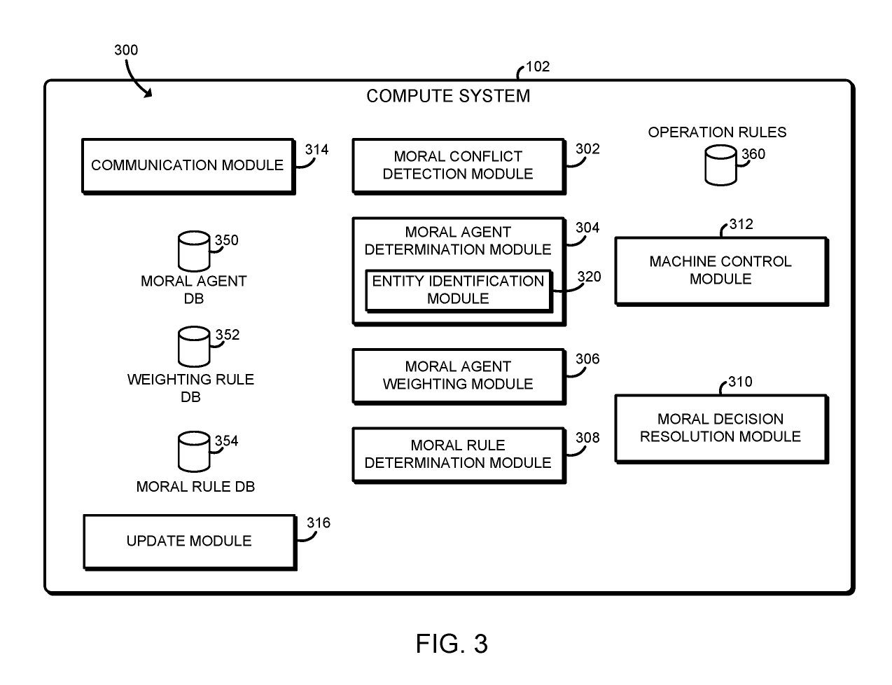

The data storage 120 may be embodied as any type of device or devices configured for short-term or long-term storage of data such as, for example, memory devices and circuits, memory cards, hard disk drives, solid-state drives, or other data storage devices. In use, the data storage 120 may store a moral agent database 350, a weighting rule database 352, a moral rule database 354, and operation rules 360 (see FIG. 3), as well as other data.

The control circuit(s) 130 may be embodied as any type of interface circuit capable of controlling one or more control devices 106 of the controlled machine 100 to control the overall operation of the controlled machine 100. The control devices 106 may be embodied as any type of device capable of controlling an operation of the controlled machine 100. For example, one or more of the control devices 106 may be embodied as physical control devices such as an actuator, a motor, an engine, and/or the like. Additionally, one or more of the control devices 106 may be embodied as an electrical control device such as a control circuit (e.g., an engine control module of a highly automated and/or autonomous vehicle). In either case, the control circuit 130 includes electrical components and circuits to facilitate communication with the control devices 106. For example, the control circuit 130 may be configured to supply a command signal at an appropriate voltage and according to an appropriate communication protocol to properly control a control device 106.

The sensor(s) 140 may be embodied as any type of sensor capable of producing sensor data usable in the control of the controlled machine 100 according to the operation rules. For example, the sensors 140 may include LIDARs, Radars, cameras, range finders, microphones, weight sensors, temperature sensors, global positioning system (GPS) sensors, and/or any other type of sensor capable of producing sensor data useful in the control of the controlled machine 100. The particular type of sensor 140 included in the controlled machine 100 may be determined based on the type of the controlled machine 100 or intended purpose of the controlled machine 100.

The communication circuit 150 may be embodied as one or more devices and/or circuitry capable of enabling communications between the controlled machine 100 and other compute systems (e.g., other compute systems controlling other machines). To do so, the communication circuit 150 may be configured to use any one or more communication technology (e.g., wired or wireless communications) and associated protocols (e.g., Ethernet, Bluetooth®, Wi-Fi®, WiMAX, etc.) to effect such communication.

Of course, the compute system 102 may include additional or other devices and/or circuits in other embodiments. For example, the compute system 102 may include one or more peripheral devices (not shown) in some embodiments. Such peripheral devices may include any type of peripheral device commonly found in a compute device such as a display, a touchscreen, speakers, a mouse, a keyboard, and/or other input/output devices, interface devices, and/or other peripheral devices.

As discussed above, the controlled machine 100 may be embodied as any type of machine capable of being controlled by the compute system 102. As shown in FIG. 2, for example, the controlled machine 100 may be embodied as an a highly automated and/or autonomous vehicle 200. In such embodiments, the compute system 102 may be incorporated in the autonomous vehicle 200 and control the operation of the autonomous vehicle 200 without direction from an occupant 202 of the autonomous vehicle 200. For example, the compute system 102 may form part of an engine control circuit, an infotainment system, or an autonomous control circuit or be embodied as a standalone control circuit. In the illustrative embodiment of FIG. 2, the control devices 106 may be embodied as, or otherwise include, a linear actuator to control the steering of the autonomous vehicle 200, an engine control module to control the fueling of the vehicle, an actuator to control the breaking, and so forth. Additionally, the sensors 140 of the compute system 102 may be embodied as, or otherwise include, a camera, a range finder, a speed sensor, and/or the like.

Referring now to FIG. 3, in the illustrative embodiment, the compute system 102 establishes an environment 300 during operation. The illustrative environment 300 includes a moral conflict detection module 302, a moral agent determination module 304, a moral agent weighting module 306, a moral rule determination module 308, a moral decision resolution module 310, a machine control module 312, a communication module 314, and an update module 316. The compute system 102 also includes the moral agent database 350, the weighting rule database 352, the moral rule database 354, and the operation rules 360. Each of the modules, logic, and other components of the environment 300 may be embodied as hardware, firmware, software, or a combination thereof. As such, in some embodiments, one or more of the modules of the environment 300 may be embodied as circuitry or collection of electrical devices (e.g., a moral conflict detection circuit 302, a moral agent determination circuit 304, a moral agent weighting circuit 306, a moral rule determination circuit 308, a moral decision resolution circuit 310, a machine control circuit 312, a communication circuit 314, and an update circuit 316). It should be appreciated that, in such embodiments, one or more of the moral conflict detection circuit 302, the moral agent determination circuit 304, the moral agent weighting circuit 306, the moral rule determination circuit 308, the moral decision resolution circuit 310, the machine control circuit 312, the communication circuit 314, and the update circuit 316 may form a portion of one or more of the processor 110, memory 112, I/O subsystem 114, data storage 120, control circuit(s) 130, sensor(s) 140, communication circuit 150, and/or other components of the compute system 102. Additionally, in some embodiments, one or more of the illustrative modules may form a portion of another module and/or one or more of the illustrative modules may be independent of one another. Further, in some embodiments, one or more of the modules of the environment 300 may be embodied as virtualized hardware components or emulated architecture, which may be established and maintained by the processor 110 or other components of the compute system 102.

The moral conflict detection module 302 is configured to detect moral conflicts during operation of the controlled machine 100. As discussed above, a moral conflict may arise for any operational decision that is undefined or otherwise unresolvable by the standard operation rules 360. For example, the moral conflict detection module 302 may monitor for those situations in which two or more rules of the operation rules conflict with each other, in which no rule is defined in the operation rules, or in which continued operation of the controlled machine 100 is otherwise unachievable based on the operation rules 360. For example, a moral conflict may arise whenever damage to property or injury to persons is involved with the operation of the controlled machine 100 (e.g., the compute system 102 is incapable of avoiding damage to some property or injury to some number of people regardless of the available choices of operation).

The moral conflict detection module 302 is also configured to determine or identify possible operational choices to resolve the moral conflict regarding the operation of the controlled machine 100. In some embodiments, the moral conflict defines the possible operational choices or a subset thereof (e.g., a choice between injuring a bystander or injuring an occupant/user of the controlled machine). Of course, the moral conflict detection module 302 may determine additional or other possible operational choices to resolve the determined moral conflict. Each operational choice defines or dictates a particular operation or set of operations of the controlled machine. For example, an operational choice may be embodied as “apply brakes at maximum pressure,” “swerve onto sidewalk,” “accelerate through red light,” “drift across lanes,” and so forth. Of course, such operational choices are merely illustrative and simplified for illustration. It should be appreciated that in many embodiments, the compute system 102 may determine a large number (e.g., dozens or more) choices in the operation of the controlled machine 100 and, such operational choices may be concretely defined and/or complex. For example, in the case of controlling movement of the controlled machine 100, the operational choices may include any random or calculated trajectory that provides a solution to the moral conflict.

The moral agent determination module 304 is configured to determine or identify moral agents likely to be affected (e.g., damaged, injured, etc.) by one or more of the possible operational choices. To do so, the moral agent determination module 304 includes an entity identification module 320 configured to identify one or more real-world entities (e.g., persons, property, etc.) likely to be affected by the possible choices. The entity identification module 320 may identify or determine the real-world entities based on sensor data produced by the sensors 140. For example, if one possible operational choice is to swerve onto the sidewalk, the entity identification module 320 may identify that a person is walking on the sidewalk based on an image produced by a camera sensor 140 and determine that the person is likely to be injured by that particular operational choice. Additionally, if another possible operational choice is to apply the brakes at maximum pressure, the entity identification module 320 may identify that a vehicle is in front of the controlled machine 100 (e.g., an autonomous vehicle) is likely to be hit and damaged by that particular operational choice.

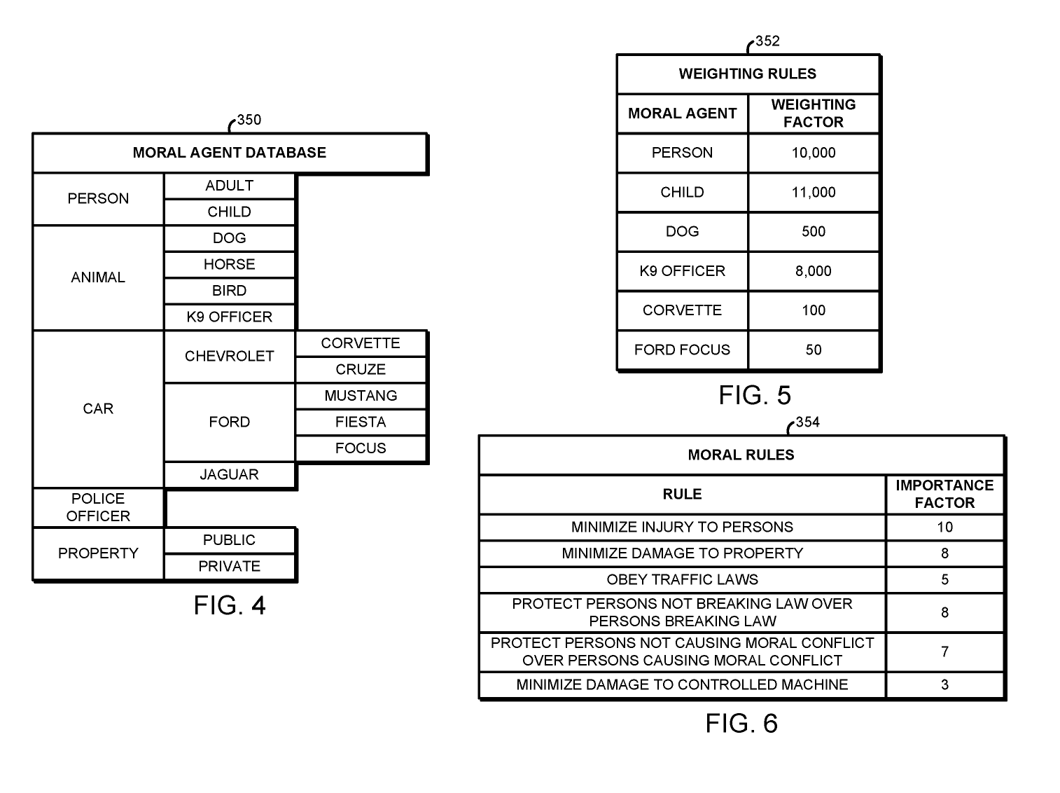

After the entity identification module 320 has identified the real-world entities likely to be affected by the possible operational choices, the moral agent determination module 304 determines one or more corresponding moral agents for each identified real-world entity. To do so, the moral agent determination module 304 may compare the real-world entities to the moral agent database 350. As discussed above, the moral agent database 350 defines those possible moral agents that may be affected by the operation of the controlled machine 100 during various situations. For example, an illustrative moral agent database 350 is shown in FIG. 4. The illustrative moral agent database 350 includes multiple tiers of moral agents, such that one real-world entity may correspond or map to multiple moral agents. For example, a K9 dog may correspond to the moral agent “animal,” “dog,” and “K9 Officer.” In such situations, the moral agent determination module 304 may identify each moral agent applicable to the single real-world entity because different weighting factors and moral rules may apply to each moral agent as discussed in more detail below. As shown in the illustrative moral agent database of FIG. 4, not all moral agents necessarily have the same tiers of granularity. Additionally, the moral agent database 350 may be different across different compute systems 102, even those controlling the same type of controlled machine 100, based on the location at which the controlled machine 100 is operated, the society in which the controlled machine 100 is operated, the type of job being performed by the controlled machine 100, and/or other factors.

Referring back to FIG. 3, the moral agent weighting module 306 is configured to apply one or more weighting factors to each moral agent determined by the moral agent determination module 304. To do so, the moral agent weighting module 306 may compare the determined moral agents to the weighting rule database. As discussed above, the weighting rule database 352 includes weighting rules that define a weighting factor to be applied to each corresponding moral agent of the moral agent database 350. The weighting factors define a level of importance or value corresponding to each moral agent. For example, an illustrative weighting rule database 352 is shown in FIG. 5. The weighting rule database 352 includes multiple weighting rules, each of which defines a weighting factor to be applied based on the type or identify of the corresponding moral agent. The weighting factor format or configuration of the weighting factor may vary based on implementation. For example, weighting factors may be represented as currency, numerical integers, percentages, or via some other representation. In some embodiments, particular values of weighting factors may be used to identify value that is a maximum, undefined, or infinite. For example, persons may be applied a weighting factor that is effectively infinite or maximum compared to the weighting factors of non-persons in some embodiments.

As discussed above, the weighting factor is an indication of a level of importance or value of each moral agent relative to each other. The weighting factors may be based on various criteria such as, for example, the cost of a property-type moral agent. Additionally, it should be appreciated that the weighting factor applied to any particular moral agent may vary across societies, time, environments, countries, and/or based on other criteria. For example, a society may weigh the importance or value of a dog much differently than another society. Additionally, over time, a property-type moral agent (e.g. a vehicle) may depreciate in value. As such and as discussed below, the weighting rules database 352 may be updated from time to time or in response to a change in the operational circumstance of the controlled machine 100 (e.g., a change in location of operation).

Referring back to FIG. 3, the moral rule determination module 308 is configured to determine moral rules applicable to the identified moral conflict. To do so, the moral rule determination module 308 may select the moral rules from the moral rule database 354 based on the possible operational choices determined by the moral conflict detection module 302, the moral agents determined by moral agent determination module 304, and/or other criteria. Each moral rule included in the moral rule databases 354 defines a goal to be achieved by the operation of the controlled machine 100. As such, the moral rule determination module 308 may select those moral rules having goals achievable, at least to some degree, by the possible operational choices and/or involving the determined moral agents. For example, an illustrative moral rule database 354 is shown in FIG. 6. The moral rule database 354 includes multiple moral rules, each of which may be applicable to a given moral conflict. For example, if the moral conflict includes the possible operational choices of “swerving onto sidewalk and striking a bystander” or “swerving into the next lane and striking a parked car,” the moral rule determination module 308 may determine that the morals rules of “minimize injury to persons,” “minimize injury to property,” “obey traffic laws,” and “minimize damage to controlled machine” are all applicable.

In some embodiments, the moral rule database 354 may include an importance factor associated with each moral rule. The importance factor identifies a level or importance of each moral rule. As discussed below, the importance factors may be used in selecting the best operational choice to resolve the moral conflict. For example, a moral rule having a higher importance factor may be selected to be satisfied over a moral rule having a lower importance factor (e.g., minimizing injury to persons vs. minimizing damage to property).

The moral rules may be defined by or based on local laws, morals, ethics, and/or other criteria of the society, country, or environment in which the controlled machine 100 is operated. As such, similar to the weighting rules, the moral rules may vary across societies, time, environments, countries, and/or based on other criteria. As such, the moral rule database 354 may be updated periodically or overtime for consistency with the society, country, time, and environment in which the controlled machine is operated.

Referring back to FIG. 3, the moral decision resolution module 310 is configured to select one of the operational choices to resolve the moral conflict related to the operation of the controlled machine 100. To do so, in the illustrative embodiment, the moral decision resolution module 310 selects the operational choice that maximizes the satisfaction of the moral rules applicable to that particular operational choice and based on the associated weighted moral agents. For example, if the compute system 102 of a highly automated and/or autonomous vehicle is faced with the moral choice of striking a jaywalker in the middle of the street or swerving onto the sidewalk and striking three bystanders, the compute system 102 may select the first choice and strike the jaywalker because that choice maximizes the “minimize injury to persons” and “protect persons not braking law over persons breaking law.” However, if the compute system 102 of the highly automated and/or autonomous vehicle is faced with the moral choice of striking a jaywalker in the middle of the street or swerving onto the sidewalk and striking a dog, the compute system 102 may select the second choice and strike the dog because that choice maximizes the “minimize injury to persons” based on the weighting factors applied to each associated moral agent. It should be appreciated that a typical highly automated and/or autonomous vehicle may not be able to perform either choice and may simply return control of the highly automated and/or autonomous vehicle back to the “driver” occupant.

Referring back to FIG. 3, the machine control module 312 is configured to control operation of the controlled machine 100 pursuant to the operational rules 360 under normal operating conditions. However, if a moral conflict has been detected and the moral decision resolution module 310 has selected the operational choice to resolve the moral conflict, the machine control module 312 is configured to perform the selected operational choice by controlling the control devices 106.

The communication module 314 is configured to facilitate communication between the compute system 102 and other compute devices via use of the communication circuit 150. For example, as discussed above, the moral agent database 350, the weighting rule database 352, and/or the moral rule database 354 may be updated by communicating with a remote server and/or other compute systems 102. As such, the communication module 314 facilitates the communications between the compute system 102 and the remote server and/or other compute systems 102 as needed.

The update module 316 is configured to manage the updating, and sharing, of the moral agent database 350, the weighting rule database 352, and/or the moral rule database 354. As discussed above, any one or more of the moral agent database 350, the weighting rule database 352, and/or the moral rule database 354 may be updated based on update data received from a remote server (e.g., a government run remote server). Additionally or alternatively, the data included in any one or more of the moral agent database 350, the weighting rule database 352, and/or the moral rule database 354 may be updated by or shared with other compute systems 102.

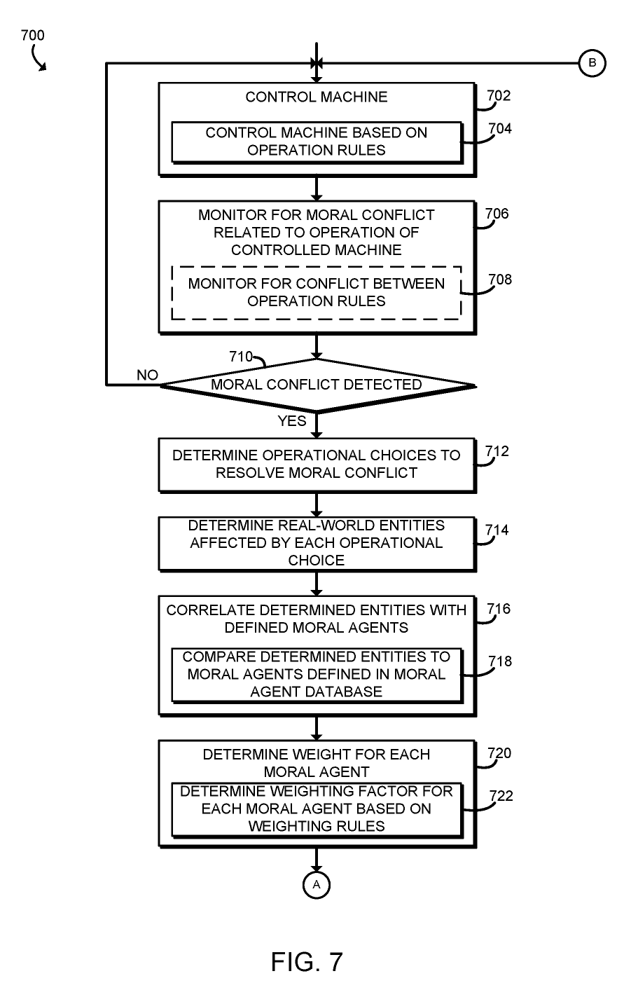

Referring now to FIG. 7, in use, the compute system 102 may execute a method 700 for controlling a controlled machine 100. The method 700 begins with block 702 in which the compute system 102 controls the operation of the controlled machine 100. For example, in block 704, the compute system 102 may control the operation of the controlled machine 100 based on the operation rules 360. During operation of the controlled machine 100, the compute system 102 monitors for a moral conflict related to the operation of the controlled machine 100 in block 706. To do so, in some embodiments in block 708, the compute system 102 may monitor for conflicts between the operational rules of the operation rule database 360 and/or for those situations in which the operational rules fail to define a suitable action to be taken.

In block 710, the compute system 102 determines whether a moral conflict has been detected. If not, the method 700 loops back to block 702 in which the compute system 102 continues to control operation of the controlled machine 100. If, however, a moral conflict has been detected or otherwise identified, the method 700 advances to block 712. In block 712, the compute system 102 determines two or more operational choices to resolve the moral conflict. As discussed above, the operational choices define an operation of the controlled machine 100 to be performed to resolve the moral conflict. In some embodiments, the operational choices (or some operational choices) may be defined by the moral conflict itself.

In block 714, the compute system 102 determines the real-world entities likely to be affected by each operational choice. To do so, as discussed above, the compute system 102 may determine those real-world entities based on the sensor data produced by the sensors 140. After the affected real-world entities have been determined in block 714, the method 700 advances to block 716 in which the compute system 102 correlates each real-world entity to one or more moral agents. As discussed above, the compute system 102 may compare the identified real-world entities to the moral agent database 350 to determine the pool of moral agents affected by each determined operational choice in block 718.

After the affected moral agents have been determined in block 716, the method 700 advances to block 720 in which the compute system 102 determines a weight for each moral agent. To do so, in block 722, the compute system 102 may determine a weighting factor for each moral agent based on the weighting rules database 352.

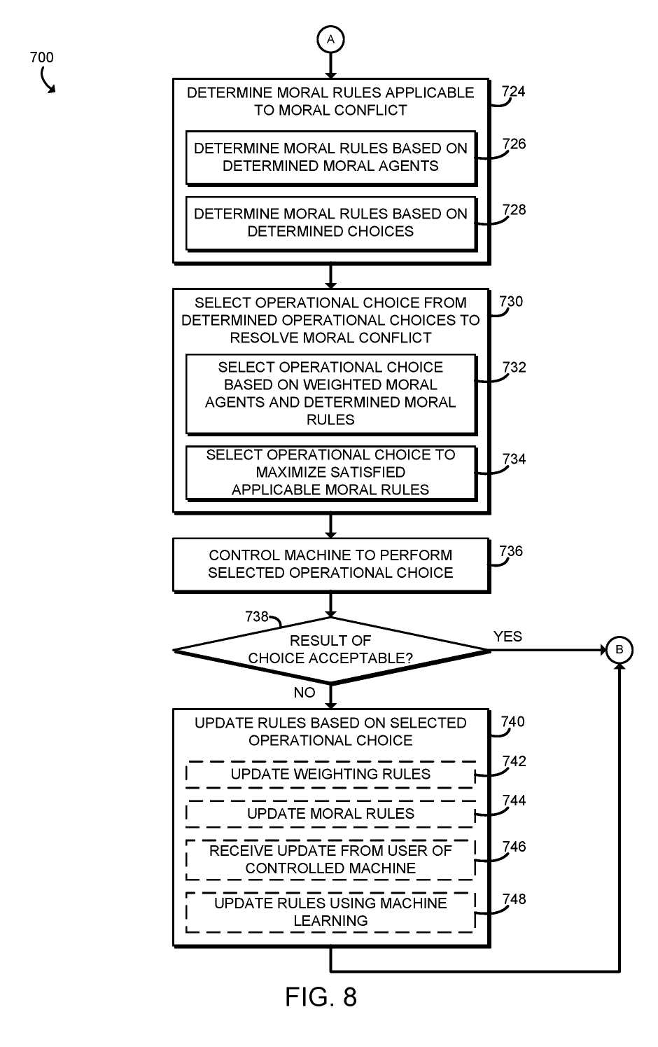

The method 700 subsequently advances to block 724 of FIG. 8 in which the compute system 102 determines one or more moral rules applicable to the identified moral conflict. To do so, the compute system 102 may select the moral rules from the moral rule database 354 based on, for example, the determined moral agents in block 726 and/or the determined operational choices in block 728. After the compute system 102 has selected the applicable moral rules in block 724, the method 700 advances to block 730 in which the compute system 102 selects one operational choice from the set of determined operational choices to resolve the moral conflict. To do so, the compute system 102 may select the operational choice based on the weighted agents and moral rules determined to be associated with each possible operational choice in block 732. For example, in some embodiments in block 734, the compute system 102 may select the operational choice that maximizes the satisfaction of the determined moral rules and/or maximizes the number of satisfied moral rules. In determining the maximization of satisfaction for the determined moral rules, the compute system 102 may utilize the weighting factors of the affected moral agents as discussed above. Additionally, the compute device may select the operational choice using any suitable methodology or algorithm such as a machine learning algorithm.

After the compute system 102 has selected the operational choice from the possible operational choices in block 730, the method 700 advances to block 736 in which the compute system 102 controls the controlled machine 100 to perform the selected operational choice. To do so, for example, the compute system 102 may control one or more control devices 106 of the controlled machine.

In some embodiments, the compute system 102 may receive feedback from a user or occupant of the controlled machine regarding the selected operational choice. Such feedback may be based on, for example, the results of the operational choice. As such, in block 738, the compute system 102 may determine whether the result of the operational choice was acceptable to the user. If so, the method 700 loops back to block 702 in which the compute system 102 continues to control the operation of the controlled machine 100. However, if not, the method 700 advances to block 740 in which the compute system 102 may update the rules based on the selected operational choice. For example, the compute system 102 may update the weighting rule database 352 in block 742 and/or update the moral rule database 354 in block 744. Such updating may be done, for example, based on the feedback from the user in block 746 and/or based on machine learning applied by the compute system 102 in block 748. Additionally or alternatively, the updating of the rules may be accomplished based on longitudinal analytics (e.g., panel analysis) in which the behavior of a massive number of compute devices and controlled machines (e.g., millions of highly automated and/or autonomous vehicles) may be analyzed to identify trends or patterns of behavior applicable to the present compute system 102 and controlled machine 100. Regardless, after the compute system 102 updates the applicable rules, the method 700 loops back to block 720 in which the compute system 102 continues to control the operation of the controlled machine 100.

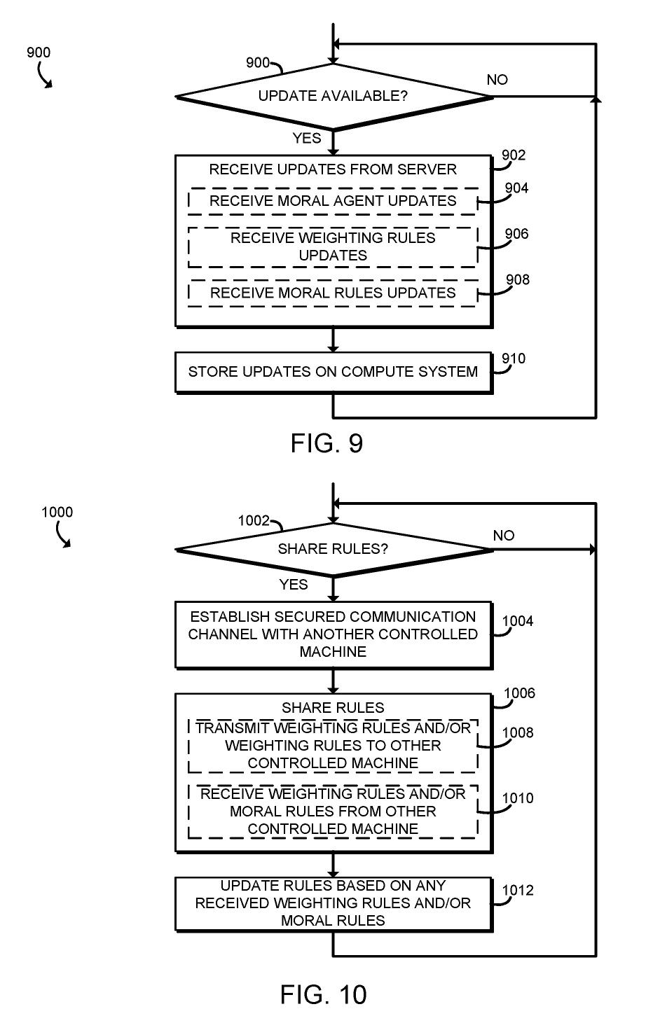

Referring now to FIG. 9, in some embodiments, the compute system 102 may execute a method 900 for updating rule data. The method 900 begins with block 902 in which the compute system 102 determines whether an update is available. For example, the compute system 102 may receive a notice from a remote server that an updated is available and/or periodically ping the remote server to check for updates. Regardless, if an update is available, the method 900 advances to block 902 in which the compute system 102 receives updated from the remote server. For example, the compute system 102 may receive moral agent updates in block 904, weighting rules updates in block 906, and/or moral rules updates in block 908. Subsequently, in block 910, the compute system 102 stores the updates in the appropriate database 350, 352, 354.

Referring now to FIG. 10, in some embodiments, the compute system 102 may also execute a method 1000 for sharing rule data with other compute systems controlling other controlled machines. Such other controlled machines may be similar or dissimilar to the controlled machine 100 the compute system 102. The method 1000 begins with block 1002 in which the compute system 102 determines whether to share rule data. For example, the compute system 102 may initiate a communication with another compute system or receive a request for initiation of a communication. Regardless, if the compute system 102 determines to share rule data in block 1002, the method 1000 advances to block 1004 in which the compute system 102 and the other compute system establish a secured communication channel. To do so, the compute system 102 may use any suitable communication protocol capable of establishing such a secured communication channel.

After the secured communication channel has been established, the method 1000 advances to block 1006 in which the compute system 102 and the other compute system share rule data. For example, in block 1008, the compute system may transmit and/or receive weighting rules to/from the other compute system. Additionally or alternatively, in block 1010, the compute system may transmit and/or receive moral rules to/from the other compute system. Regardless, after the compute system 102 has shared the rule data in block 1006, the method 1000 advances to block 1012 in which the compute system 102 updates the weighting rule database 352 and/or the moral rule database 354 based on the shared rule data.

### EXAMPLES

Illustrative examples of the devices, systems, and methods disclosed herein are provided below. An embodiment of the devices, systems, and methods may include any one or more, and any combination of, the examples described below.

Example 1 includes a compute system to control operation of a machine. The compute system includes a data storage to store (i) a moral agent database that includes a plurality of moral agents, (i) a weighting rule database that includes a plurality of weighting rules, wherein each weighting rule defines a weighting factor for a corresponding moral agent, and (iii) a moral rule database that includes a plurality of moral rules, wherein each moral rule defines a goal to be achieved by the operation of the machine; a moral conflict detection module to (i) detect a moral conflict related to the operation of the machine and (ii) determine a plurality of operational choices to resolve the moral conflict, wherein each operational choice defines a corresponding operation of the machine; a moral agent determination module to determine, for each defined operational choice, a moral agent from the moral agent database that is to be affected by the corresponding operational choice; a moral agent weighting module to apply a weighting factor to each determined moral agent based on one or more weighting rules of the plurality of weighting rules; a moral agent weighting module to determine one or more moral rules from the plurality of moral rules that are applicable to the moral conflict; and a moral decision resolution module to select an operational choice from the plurality of operational choices to resolve the moral conflict based on the weighted moral agents and the determined moral rules.

Example 2 includes the subject matter of Example 1, and wherein the data storage is further to store an operational database that includes a plurality of operational rules and wherein the operational rules dictate the operation of the machine, and wherein to detect the moral conflict comprises to detect a conflict between two or more operational rules of the plurality of operational rules.

Example 3 includes the subject matter of any of Examples 1 or 2, and further comprising a sensor to produce sensor data, and wherein to detect the moral conflict comprises to detect the moral conflict based on the conflict between the two or more operational rules and the sensor data.

Example 4 includes the subject matter of any of Examples 1-3, and wherein to determine the moral agents comprises to determine, for each operational choice, one or more real-world entities that are to be affected by the corresponding operational choice; and match each real-world entity with a corresponding moral agent defined in the moral agent database.

Example 5 includes the subject matter of any of Examples 1-43, and wherein to determine the real-world entities comprises to determine, for each operational choice, one or more real-world entities likely to be damaged by the corresponding operational choice.

Example 6 includes the subject matter of any of Examples 1-5, and wherein to apply the weighting factor to each moral agent comprises to apply multiple weighting factors to a single moral agent based on the one or more weighting rules.

Example 7 includes the subject matter of any of Examples 1-6, and wherein to apply the weighting factor to each moral agent comprises to select a highest weighting factor for a single moral agent from a plurality of weighting factors applicable to the single moral agent.

Example 8 includes the subject matter of any of Examples 1-7, and wherein to determine the one or more moral rules applicable to the moral conflict comprises to determine one or more moral rules applicable to the conflict based on at least one moral agent.

Example 9 includes the subject matter of any of Examples 1-8, and wherein to determine the one or more moral rules applicable to the moral conflict comprises to determine one or more moral rules applicable to the conflict based on at least one operational choice of the plurality of the operational choices.

Example 10 includes the subject matter of any of Examples 1-9, and wherein to select the operational choice comprises to select an operational choice from the plurality of operational choices based on the weighting factor applied to each moral agent.

Example 11 includes the subject matter of any of Examples 1-10, and wherein to select the operational choice comprises to select an operational choice from the plurality of operational choices based on a number of determined moral rules satisfied by the selected operational choice.

Example 12 includes the subject matter of any of Examples 1-11, and wherein to select the operational choice comprises to select an operational choice from the plurality of operational choices based on (i) a number of determined moral rules satisfied by the selected operational choice and (ii) the weighting factor applied to the moral agent affected by the selected operational choice.

Example 13 includes the subject matter of any of Examples 1-12, and wherein each moral rule includes an associated importance factor that indicates a level of importance of satisfying the corresponding moral rule relative to other moral rules, and wherein to select the operational choice comprises to select an operational choice from the plurality of operational choices based on the importance factor of each determined moral rule.

Example 14 includes the subject matter of any of Examples 1-13, and further comprising a machine control module to control the machine to perform the selected operational choice.

Example 15 includes the subject matter of any of Examples 1-14, and further comprising an update module to determine, by the compute system, a result of the performance of the selected operational choice; and update, by the compute system and based on the result, at least one of the moral agent database, the weighting rule database, or the moral rule database.

Example 16 includes the subject matter of any of Examples 1-15, and further comprising a communication module to receive update data from another compute system controlling another machine; and an update module to update at least one of a moral agent database, the weighting rules, or the moral rules with the update data.

Example 17 includes a method for controlling a machine. The method includes detecting, by a compute system controlling operation of the machine, a moral conflict related to the operation of the machine; determining, by the compute device, a plurality of operational choices to resolve the moral conflict, wherein each operational choice defines a corresponding operation of the machine; determining, by the compute system and for each defined operational choice, a moral agent from a moral agent database that is to be affected by the corresponding operational choice; applying, by the compute system, a weighting factor to each determined moral agent based on one or more weighting rules, wherein each weighting rule defines a weighting factor for a corresponding moral agent; determining, by the compute system, one or more moral rules applicable to the moral conflict, wherein each moral rule defines a goal to be achieved by the operation of the machine; and selecting, by the compute system, an operational choice from the plurality of operational choices to resolve the moral conflict based on the weighted moral agents and the determined moral rules.

Example 18 includes the subject matter of Example 17, and wherein detecting the moral conflict comprises detecting a conflict between two or more operational rules of the machine, wherein the operational rules dictate the operation of the machine.

Example 19 includes the subject matter of Examples 17 or 18, and wherein detecting the moral conflict comprises detecting the moral conflict based on the conflict between the two or more operational rules and sensor data received from one or more sensors of the compute device.

Example 20 includes the subject matter of any of Examples 17-19, and wherein determining the moral agents comprises determining, for each operational choice, one or more real-world entities affected by the corresponding operational choice; and matching each real-world entity with a corresponding moral agent defined in the moral agent database.

Example 21 includes the subject matter of any of Examples 17-20, and wherein determining the real-world entities comprises determining, for each operational choice, one or more real-world entities likely to be damaged by the corresponding operational choice.

Example 22 includes the subject matter of any of Examples 17-21, and wherein applying the weighting factor to each moral agent comprises applying multiple weighting factors to a single moral agent based on the one or more weighting rules.

Example 23 includes the subject matter of any of Examples 17-22, and wherein applying the weighting factor to each moral agent comprises selecting a highest weighting factor for a single moral agent from a plurality of weighting factors applicable to the single moral agent.

Example 24 includes the subject matter of any of Examples 17-23, and wherein determining the one or more moral rules applicable to the moral conflict comprises determining one or more moral rules applicable to the conflict based on at least one moral agent.

Example 25 includes the subject matter of any of Examples 17-24, and wherein determining the one or more moral rules applicable to the moral conflict comprises determining one or more moral rules applicable to the conflict based on at least one operational choice of the plurality of the operational choices.

Example 26 includes the subject matter of any of Examples 17-25, and wherein selecting the operational choice comprises selecting an operational choice from the plurality of operational choices based on the weighting factor applied to each moral agent.

Example 27 includes the subject matter of any of Examples 17-26, and wherein selecting the operational choice comprises selecting an operational choice from the plurality of operational choices based on a number of determined moral rules satisfied by the selected operational choice.

Example 28 includes the subject matter of any of Examples 17-27, and wherein selecting the operational choice comprises selecting an operational choice from the plurality of operational choices based on (i) a number of determined moral rules satisfied by the selected operational choice and (ii) the weighting factor applied to the moral agent affected by the selected operational choice.

Example 29 includes the subject matter of any of Examples 17-28, and wherein each moral rule includes an associated importance factor that indicates a level of importance of satisfying the corresponding moral rule relative to other moral rules, and wherein selecting the operational choice comprises selecting an operational choice from the plurality of operational choices based on the importance factor of each determined moral rule.

Example 30 includes the subject matter of any of Examples 17-20, and further comprising controlling, by the compute system, the machine to perform the selected operational choice.

Example 31 includes the subject matter of any of Examples 17-30, and further comprising: determining, by the compute system, a result of the performance of the selected operational choice; and updating, by the compute system and based on the result, at least one of the moral agent database, the weighting rules, or the moral rules stored on the compute system.

Example 32 includes the subject matter of any of Examples 17-31, and further comprising receiving, by the compute system, update data from another compute system controlling another machine; and updating, by the compute system, at least one of the moral agent database, the weighting rules, or the moral rules with the update data.

Example 33 includes one or more computer-readable storage media comprising a plurality of instructions that, when executed, cause a compute system to perform the method of any of Examples 17-32.

Example 34 includes a compute system to control operation of a machine. The compute system comprising means for detecting a moral conflict related to the operation of the machine; means for determining a plurality of operational choices to resolve the moral conflict, wherein each operational choice defines a corresponding operation of the machine; means for determining, for each defined operational choice, a moral agent from a moral agent database that is to be affected by the corresponding operational choice; means for applying a weighting factor to each determined moral agent based on one or more weighting rules, wherein each weighting rule defines a weighting factor for a corresponding moral agent; means for determining one or more moral rules applicable to the moral conflict, wherein each moral rule defines a goal to be achieved by the operation of the machine; and means for selecting an operational choice from the plurality of operational choices to resolve the moral conflict based on the weighted moral agents and the determined moral rules.

Example 35 includes the subject matter of Example 34, and wherein the means for detecting the moral conflict comprises means for detecting a conflict between two or more operational rules of the machine, wherein the operational rules dictate the operation of the machine.

Example 36 includes the subject matter of Example 34 or 35, and wherein the means for detecting the moral conflict comprises means for detecting the moral conflict based on the conflict between the two or more operational rules and sensor data received from one or more sensors of the compute device.

Example 37 includes the subject matter of any of Examples 34-36, and wherein the means for determining the moral agents comprises means for determining, for each operational choice, one or more real-world entities affected by the corresponding operational choice; and means for matching each real-world entity with a corresponding moral agent defined in the moral agent database.

Example 38 includes the subject matter of any of Examples 34-37, and wherein the means for determining the real-world entities comprises means for determining, for each operational choice, one or more real-world entities likely to be damaged by the corresponding operational choice.

Example 39 includes the subject matter of any of Examples 34-38, and wherein the means for applying the weighting factor to each moral agent comprises means for applying multiple weighting factors to a single moral agent based on the one or more weighting rules.

Example 40 includes the subject matter of any of Examples 34-39, and wherein the means for applying the weighting factor to each moral agent comprises means for selecting a highest weighting factor for a single moral agent from a plurality of weighting factors applicable to the single moral agent.

Example 41 includes the subject matter of any of Examples 34-40, and wherein the means for determining the one or more moral rules applicable to the moral conflict comprises means for determining one or more moral rules applicable to the conflict based on at least one moral agent.

Example 42 includes the subject matter of any of Examples 34-41, and wherein the means for determining the one or more moral rules applicable to the moral conflict comprises means for determining one or more moral rules applicable to the conflict based on at least one operational choice of the plurality of the operational choices.

Example 43 includes the subject matter of any of Examples 34-42, and wherein the means for selecting the operational choice comprises means for selecting an operational choice from the plurality of operational choices based on the weighting factor applied to each moral agent.

Example 44 includes the subject matter of any of Examples 34-43, and wherein the means for selecting the operational choice comprises means for selecting an operational choice from the plurality of operational choices based on a number of determined moral rules satisfied by the selected operational choice.

Example 45 includes the subject matter of any of Examples 34-44, and wherein the means for selecting the operational choice comprises means for selecting an operational choice from the plurality of operational choices based on (i) a number of determined moral rules satisfied by the selected operational choice and (ii) the weighting factor applied to the moral agent affected by the selected operational choice.

Example 46 includes the subject matter of any of Examples 34-45, and wherein each moral rule includes an associated importance factor that indicates a level of importance of satisfying the corresponding moral rule relative to other moral rules, and wherein the means for selecting the operational choice comprises means for selecting an operational choice from the plurality of operational choices based on the importance factor of each determined moral rule.

Example 47 includes the subject matter of any of Examples 34-46, and further comprising the means for controlling the machine to perform the selected operational choice.

Example 48 includes the subject matter of any of Examples 34-47, and further comprising means for determining a result of the performance of the selected operational choice; and means for updating, based on the result, at least one of the moral agent database, the weighting rules, or the moral rules stored on the compute system.

Example 49 includes the subject matter of any of Examples 34-48, and further comprising means for receiving update data from another compute system controlling another machine; and means for updating at least one of the moral agent database, the weighting rules, or the moral rules with the update data.

1. A compute system to control operation of a machine, the compute system comprising:
a data storage to store (i) a moral agent database that includes a plurality of moral agents, (i) a weighting rule database that includes a plurality of weighting rules, wherein each weighting rule defines a weighting factor for a corresponding moral agent, and (iii) a moral rule database that includes a plurality of moral rules, wherein each moral rule defines a goal to be achieved by the operation of the machine;
a moral conflict detection module to (i) detect a moral conflict related to the operation of the machine and (ii) determine a plurality of operational choices to resolve the moral conflict, wherein each operational choice defines a corresponding operation of the machine;
a moral agent determination module to determine, for each defined operational choice, a moral agent from the moral agent database that is to be affected by the corresponding operational choice;
a moral agent weighting module to apply a weighting factor to each determined moral agent based on one or more weighting rules of the plurality of weighting rules;
a moral agent weighting module to determine one or more moral rules from the plurality of moral rules that are applicable to the moral conflict; and
a moral decision resolution module to select an operational choice from the plurality of operational choices to resolve the moral conflict based on the weighted moral agents and the determined moral rules.

2. The compute system of claim 1, wherein the data storage is further to store an operational database that includes a plurality of operational rules and wherein the operational rules dictate the operation of the machine, and
wherein to detect the moral conflict comprises to detect a conflict between two or more operational rules of the plurality of operational rules.

3. The compute system of claim 1, wherein to determine the moral agents comprises to:
determine, for each operational choice, one or more real-world entities that are to be affected by the corresponding operational choice; and
match each real-world entity with a corresponding moral agent defined in the moral agent database.

4. The compute system of claim 1, wherein to determine the one or more moral rules applicable to the moral conflict comprises to determine one or more moral rules applicable to the conflict based on at least one moral agent.

5. The compute system of claim 1, wherein to determine the one or more moral rules applicable to the moral conflict comprises to determine one or more moral rules applicable to the conflict based on at least one operational choice of the plurality of the operational choices.

6. The compute system of claim 1, wherein to select the operational choice comprises to select an operational choice from the plurality of operational choices based on the weighting factor applied to each moral agent.

7. The compute system of claim 1, wherein to select the operational choice comprises to select an operational choice from the plurality of operational choices based on a number of determined moral rules satisfied by the selected operational choice.

8. The compute system of claim 1, wherein each moral rule includes an associated importance factor that indicates a level of importance of satisfying the corresponding moral rule relative to other moral rules, and
wherein to select the operational choice comprises to select an operational choice from the plurality of operational choices based on the importance factor of each determined moral rule.

9. The compute system of claim 1, further comprising a machine control module to control the machine to perform the selected operational choice.

10. A method for controlling a machine, the method comprising:
detecting, by a compute system controlling operation of the machine, a moral conflict related to the operation of the machine;
determining, by the compute device, a plurality of operational choices to resolve the moral conflict, wherein each operational choice defines a corresponding operation of the machine;
determining, by the compute system and for each defined operational choice, a moral agent from a moral agent database that is to be affected by the corresponding operational choice;
applying, by the compute system, a weighting factor to each determined moral agent based on one or more weighting rules, wherein each weighting rule defines a weighting factor for a corresponding moral agent;
determining, by the compute system, one or more moral rules applicable to the moral conflict, wherein each moral rule defines a goal to be achieved by the operation of the machine; and
selecting, by the compute system, an operational choice from the plurality of operational choices to resolve the moral conflict based on the weighted moral agents and the determined moral rules.

11. The method of claim 10, wherein detecting the moral conflict comprises detecting a conflict between two or more operational rules of the machine, wherein the operational rules dictate the operation of the machine.

12. The method of claim 10, wherein determining the moral agents comprises:
determining, for each operational choice, one or more real-world entities affected by the corresponding operational choice; and
matching each real-world entity with a corresponding moral agent defined in the moral agent database.

13. The method of claim 10, wherein determining the one or more moral rules applicable to the moral conflict comprises determining one or more moral rules applicable to the conflict based on at least one moral agent or at least one operational choice of the plurality of the operational choices.

14. The method of claim 10, wherein selecting the operational choice comprises selecting an operational choice from the plurality of operational choices based on the weighting factor applied to each moral agent.

15. The method of claim 10, wherein selecting the operational choice comprises selecting an operational choice from the plurality of operational choices based on a number of determined moral rules satisfied by the selected operational choice.

16. The method of claim 10, wherein each moral rule includes an associated importance factor that indicates a level of importance of satisfying the corresponding moral rule relative to other moral rules, and
wherein selecting the operational choice comprises selecting an operational choice from the plurality of operational choices based on the importance factor of each determined moral rule.

17. The method of claim 10, further comprising controlling, by the compute system, the machine to perform the selected operational choice.

18. One or more computer-readable storage media comprising a plurality of instructions that, when executed by a compute system, cause the compute system to:
detect a moral conflict related to the operation of the machine;
determine a plurality of operational choices to resolve the moral conflict, wherein each operational choice defines a corresponding operation of the machine;
determine, for each defined operational choice, a moral agent from a moral agent database that is to be affected by the corresponding operational choice;
apply a weighting factor to each determined moral agent based on one or more weighting rules, wherein each weighting rule defines a weighting factor for a corresponding moral agent;
determine one or more moral rules applicable to the moral conflict, wherein each moral rule defines a goal to be achieved by the operation of the machine; and
select an operational choice from the plurality of operational choices to resolve the moral conflict based on the weighted moral agents and the determined moral rules.

19. The method of claim 18, wherein to detect the moral conflict comprises to detect a conflict between two or more operational rules of the machine, wherein the operational rules dictate the operation of the machine.

20. The method of claim 18, wherein to determine the moral agents comprises to:
determine, for each operational choice, one or more real-world entities affected by the corresponding operational choice; and
match each real-world entity with a corresponding moral agent defined in the moral agent database.

21. The method of claim 18, wherein to determine the one or more moral rules applicable to the moral conflict comprises to determine one or more moral rules applicable to the conflict based on at least one moral agent or at least one operational choice of the plurality of the operational choices.

22. The method of claim 18, wherein to select the operational choice comprises to select an operational choice from the plurality of operational choices based on the weighting factor applied to each moral agent.

23. The method of claim 18, wherein to select the operational choice comprises to select an operational choice from the plurality of operational choices based on a number of determined moral rules satisfied by the selected operational choice.

24. The method of claim 18, wherein each moral rule includes an associated importance factor that indicates a level of importance of satisfying the corresponding moral rule relative to other moral rules, and
wherein to select the operational choice comprises to select an operational choice from the plurality of operational choices based on the importance factor of each determined moral rule.

25. The method of claim 18, wherein the plurality of instructions that, when executed by the compute system, further cause the compute system to control the machine to perform the selected operational choice.
